(19) United States
(12) Patent Application Publication
(10) Pub. No.: US 2006/0031531 A1
(43) Pub. Date: Feb. 9, 2006

(54) Networkable appliance

(75) Inventors: Hayato Ikebe, Osaka (JP); Youko Tanaka, Mizuho-City (JP); Kazuya Ogawa, Mizuho-City (JP); Yoshinori Hatayama, Komaki City (JP); Hiroshi Takemura, Aisai-City (JP)

Correspondence Address: MCDERMOTT WILL & EMERY LLP, 600 13TH STREET, N.W., WASHINGTON, DC, 20005-3096, US

(73) Assignee: SANYO Electric Co., Ltd.

(21) Appl. No.: 11/169,663

(22) Filed: Jun. 30, 2005

(30) Foreign Application Priority Data
Jun. 30, 2004 (JP) 2004-195079
Apr. 28, 2005 (JP) 2005-130655

(51) Int. Cl. G06F 15/16

(52) U.S. Cl. 709/227

(57) ABSTRACT

Provided is a client/server system in which clients (terminal appliances) can uniquely determine to which server they are to be connected irrespective of whether a network has a single or plural servers. When connected to the network, a client obtains function information of each server on the network, and sets the server of the highest function, for example, as the server to which the clients are to be connected. A server compares, when a new server is connected to the network, its own function against the function of the server newly connected to the network to determine to which of the servers the clients are to be connected. The result is notified to the clients. Thus, to which server clients are to be connected is uniquely determined in a multi-server/multi-client network configuration.

### BACKGROUND OF THE INVENTION

1. Field of the Invention

The present invention relates to a networkable appliance connected to a network. In particular, the present invention relates to a technique suitable for a case where plural network appliances each having a server function are connected to a network.

2. Description of the Related Art

The recent propagation of networks represented by the Internet has evoked a growing demand to connect appliances in a house to a network and control the appliances via the network from outside of the house as well as from inside.

To build a home network, terminal appliances with a network function (hereinafter referred to as clients) and a server for controlling the clients are necessary. In the case of hooking up many clients to a server, there is a user's financial burden of building a home network including the cost of introducing a high function server.

On the other hand, when only a small number of clients are to be hooked up, a home network can be built by installing a simplified server function to one of the clients instead of introducing a high-level function server to the home network. In this case, the one of the clients that has the server function unifies management of information in order to control the clients on the network. A possible problem of this form of home network is in that the processing ability of the simplified server function may not be enough to handle a future increase in number of clients connected to the network. Then the user has no choice but to add a high function server having satisfactory processing ability to the home network.

A network can thus take various forms in terms of the combination of clients and a server. Each time a network configuration is changed or expanded by addition or the like, a user has to newly set the network to accommodate the change so that, for example, destination address to connect is automatically switched.

JP 2000-354062 A describes a technique for lessening the burden of setting processing on a user's part in such cases. This publication specifically discloses a configuration with which the address of a newly added server or of a newly added communication device can be registered automatically without a manual operation by a network administrator. This configuration facilitates registration of a server address and a communication device address, thereby lessening the burden of the network administrator.

While the publication shows a technical concept of automatically registering, to a network, the address of a server or communication device newly added to the network as mentioned above, it does not disclose to which one of plural servers appliances are to be uniquely connected when there are plural servers on a network.

### SUMMARY OF THE INVENTION

The present invention has been made in view of the above circumstances, and an object of the present invention is therefore to provide a client/server system in which every client is capable of uniquely determining to which server it is to be connected irrespective of whether a network has a single or plural servers.

A first aspect of the present invention relates to a networkable appliance (client) connected to a network, including: a connection notification transmitting unit for sending, to appliances on the network, information to notify the appliances of the fact of being connected to the network; an information receiving unit for receiving information sent from other appliances on the network; and a connection management unit which, when information received by the information receiving unit is response information sent from an appliance with a server function (server) in response to the information sent by the connection notification transmitting unit, compares the server function of one appliance to the server function of another appliance based on the received response information, which determines, in accordance with the result of the comparison, to which appliance with a server function the networkable appliance is to be connected, and which exerts control to connect the networkable appliance to the determined appliance with a server function.

A networkable appliance (client) according to the first aspect of the invention compares, for itself, when it is hooked up to a network, the function of one networkable appliance with a server function (server) on the network to that of another server on the network. The server that is found as a result of the comparison to have the highest server function, for example, is set as the server to which this client is to be connected. Therefore, according to the first aspect of the present invention, a client itself uniquely determines to which server it is to be connected when hooked up to a network.

The networkable appliance according to the first aspect of the invention may further include a memory unit for storing the appliance with a server function to which the networkable appliance is connected by the connection management unit in association with the response information received by the information receiving unit from this appliance with a server function.

Also, the networkable appliance according to the first aspect of the invention may further include a disconnection detecting unit for detecting that a connection to the appliance with a server function (server) is cut, in which: when the disconnection detecting unit detects that a connection to the appliance with a server function (server) is cut, the connection notification transmitting unit retransmits, to the appliances on the network, the information to notify the appliances of the fact of being connected to the network; and based on response information sent from the appliance with a server function (server) in response to the information retransmitted from the connection notification transmitting unit, the connection management unit determines to which appliance with a server function (server) the networkable appliance is to be newly connected, and exerts control to connect the networkable appliance to the determined appliance with a server function (server).

According to this aspect of the present invention, in such a case where a server set to be connected to a client is removed from the network or stops functioning, the client again compares the functions of the servers on the network. The server that is found as a result of the comparison to have the highest-level server function, for example, is set as the server to which this client is to be connected. Therefore, according to this aspect of the present invention, a client itself uniquely determines to which server it is to be connected also when a server to which it has been connected is removed from the network or stops functioning.

Moreover, the networkable appliance according to the first aspect of the invention may further include: a memory unit for storing information of an appliance with a server function (server) that is chosen by the networkable appliance as the server to which the networkable appliance is to be connected; and a server determining unit which, when information received by the information receiving unit is information sent from an appliance with a server function (server) that is newly connected to the network, compares the server function (server) of one appliance to the server function (server) of another appliance based on the received information and the information stored in the memory unit, and which determines, in accordance with the result of the comparison, to which appliance with a server function (server) the networkable appliance is to be connected.

According to this aspect of the present invention, when a server is newly connected to a network of a client, the client compares the function of the server to which it is currently connected against the function of the server newly connected to the network. In the case where the server newly connected to the network is found to have a higher function, the new server is set as the server to which this client is to be connected. Therefore, according to this aspect of the present invention, a client itself uniquely determines to which server it is to be connected also when a new server is connected to a network of the client.

A second aspect of the present invention relates to a networkable appliance (client) connected to a network, including: an information receiving unit for receiving information sent from appliances on the network; a memory unit for storing information of an appliance with a server function that is chosen by the networkable appliance as the server to which the networkable appliance is to be connected; a server determining unit which, when information received by the information receiving unit is information sent from an appliance with a server function that is newly connected to the network, compares the server function of one appliance to the server function of another appliance based on the received information and the information stored in the memory unit, and which determines, in accordance with the result of the comparison, to which appliance with a server function the networkable appliance is to be connected; and a connection management unit which exerts control to connect the networkable appliance to the appliance with a server function that is determined by the server determining unit.

A networkable appliance (client) according to the second aspect of the invention compares, when an appliance with a server function (server) is newly connected to its network, the function of the server to which it is currently connected against the function of the server newly connected to the network. In the case where the server newly connected to the network is found to have a higher function, the new server is set as the server to which this client is to be connected. Therefore, according to the second aspect of the present invention, a client itself uniquely determines to which server it is to be connected when a new server is connected to its network.

In the networkable appliance according to the second aspect of the invention, the connection management unit disconnects, when the appliance with a server function that is determined by the server determining unit is not an appliance with a server function to which the networkable appliance is currently connected, the networkable appliance from the currently connected appliance, and connects the networkable appliance to the appliance that is determined by the server determining unit.

A third aspect of the present invention relates to a networkable appliance with a server function (server), including: a connection notification transmitting unit for sending, to appliances on a network, information to notify the appliances of the fact of being connected to the network; an information receiving unit for receiving information sent from appliances on the network; a memory unit for storing information of its own server function; and a client-connected server determining unit which, when information received by the information receiving unit is information notifying of the fact that another appliance with a server function (server) is connected to the network, compares the function of its own against the function of the other appliance (server) based on the received information and the information stored in the memory unit, and which determines, in accordance with the result of the comparison, to which appliance with a server function (server) the appliances on the network are to be connected; and a client-connected server notification unit for sending, to the appliances connected to the network, information indicative of the appliance that is determined by the client-connected server determining unit as the server to which the appliances are to be connected.

A networkable appliance (server) according to the third aspect of the invention compares, when an appliance with a server function (server) is newly connected to its network, its own function against the function of the server newly connected to the network. In the case where the server newly connected to the network is found to have a higher function, the new server is set as the server to which clients on the network are to be connected, and information to that effect is sent to each client. Therefore, according to the third aspect of the present invention, a server uniquely determines to which server clients are to be connected when a new server is connected to its network.

According to these aspects of the present invention, when the configuration of a network is changed by addition of a new server or client to the network or by a server ceasing its function, clients are uniquely connected to one of servers without burdening a user.

In the case where appliances are connected at user's discretion and a network system configuration is determined accordingly as in a home network, some users may have difficulties in envisioning what configuration the system will end up taking. The present invention enables a user who may not have technical knowledge to optimize a network system upon the system's configurational change without the user being particularly conscious of doing so, let alone causing any difficulties to the user. For instance, a highly expandable network system can be built by setting the system such that a client is switched to a new server hooked up to the system if the new server has a higher function than one to which the client has been connected.

### BRIEF DESCRIPTION OF THE DRAWINGS

The aforementioned and other objects and novel characteristics of the present invention will be understood more clearly when the following description of embodiments are read in conjunction with the accompanying drawings in which:

FIGS. 1A and 1B show configuration examples of a network system according to an embodiment mode of the present invention;

FIG. 2 shows a configuration example of a network system according to a first embodiment of the present invention;

FIG. 3 shows a client function block according to the first embodiment;

FIG. 4 shows a server function block according to the first embodiment;

FIGS. 5A, 5B, 5C and 5D show examples of messages handled in the network system according to the first embodiment;

FIG. 6 shows an example of server information according to the first embodiment;

FIGS. 7A and 7B are flow charts for when a client is connected according to the first embodiment;

FIG. 8 is a flow chart for when a client switches connecting server according to the first embodiment;

FIG. 9 is a flow chart for when a server is selected according to the first embodiment;

FIGS. 10A and 10B are flowcharts for when a server is connected according to the first embodiment;

FIG. 11 is a sever processing flow chart for when a new server is added to network according to the first embodiment;

FIG. 12 shows a client function block according to a second embodiment of the present invention;

FIG. 13 shows a server function block according to the second embodiment;

FIGS. 14A, 14B and 14C show examples of messages handled by a network system according to the second embodiment;

FIG. 15 is a flowchart for when a client is connected according to the second embodiment;

FIG. 16 is a client processing flow chart for when client-connected server is switched according to the second embodiment; and

FIG. 17 is a server processing flow chart for when a new sever is added to network according to the second embodiment.

### DETAILED DESCRIPTION OF THE PREFERRED EMBODIMENTS

An embodiment mode of the present invention will be described with reference to the accompanying drawings.

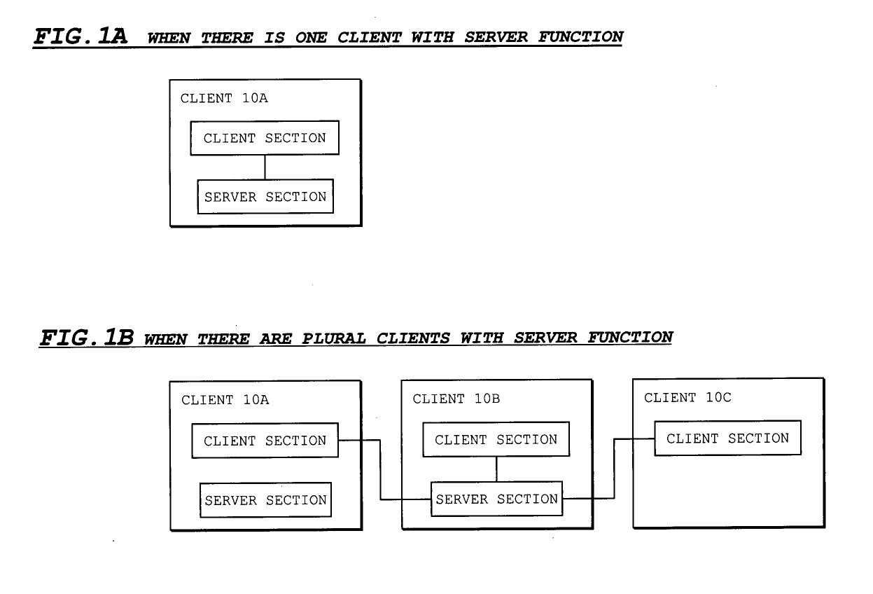

FIGS. 1A and 1B show configuration examples of a network system according to the embodiment mode.

Shown in FIG. 1A is a network system configuration example in which there is one client 10A with a server function on a network. When the server client 10A has one platform only on the network, the client 10A is connected to its own server section.

Shown in FIG. 1B is a network system configuration example in which plural clients have server functions. When a client 10B with a server function and a client 10C without a server function are newly connected to the network to which the client 10A with a server function has been connected, data (a message) is exchanged via the network to compare the functionalities of the servers against each other and processing is executed for the respective clients to judge to which server the clients are to be connected.

If the function of a server section loaded in the client 10B is superior to the function of the server section loaded in the client 10A, the server section of the newly connected client 10B is chosen as a new server to which the clients are to be connected. Then the client 10A disconnects from its own server section and establishes a connection with the server section of the client 10B.

If the function of the server section in the newly connected client 10B is equal to the function of the server section in the client 10A to which the client is currently connected, the server section that has at present more clients connected thereto, namely, the server section in the existing client 10A, is chosen as the server to which the clients are to be connected. In this case, the clients 10B and 10C newly connected to the network establish a connection to the server section in the client 10A which is currently functioning as the server.

If the function of the server section in the client 10A to which the client is currently connected is superior to the function of the server section in the newly connected client 10B, the clients 10B and 10C newly connected to the network are connected to the server section in the client 10A to which the existing client has been connected.

Thus, when plural clients are connected to a network, the server section that has the highest-level function is chosen as the server to which the clients are connected. Since to which server clients are to be connected is determined uniquely, information to be processed can be managed in a centralized manner by the chosen server.

FIGS. 1A and 1B show as examples cases in which clients with server functions are connected to a network. The above-described process of choosing where clients are to be connected is also applicable when servers, instead of clients with server functions, are connected to a network. To be specific, in the case where servers and clients with server functions are connected to a network, the functions of the servers and of server sections of the clients are compared to choose the server or server section that has the highest-level function as to where the clients are to be connected to.

Now, a detailed description is given on embodiments of the present invention.

In the following description, TCP/IP (Transmission Control Protocol)/(Internet Protocol) and UDP (User Datagram Protocol) are used as communications protocols over a network. Messages exchanged between a client and a server are written in a markup language according to XML (extensible Markup Language). Messages exchanged between a client and a server are sent and received by IP multicast or UDP unicast or TCP.

The embodiments below deal with the operation of clients and servers when a client or a server is connected to a network, and with server-client connection processing. Other communication processing such as server-client communication processing is similar to the one in prior art and, accordingly, a description thereof is omitted.

In the following description, an appliance with a client function only is called as a client, whereas an appliance with a server function (including a client with a server function) is called as a server.

(First Embodiment)

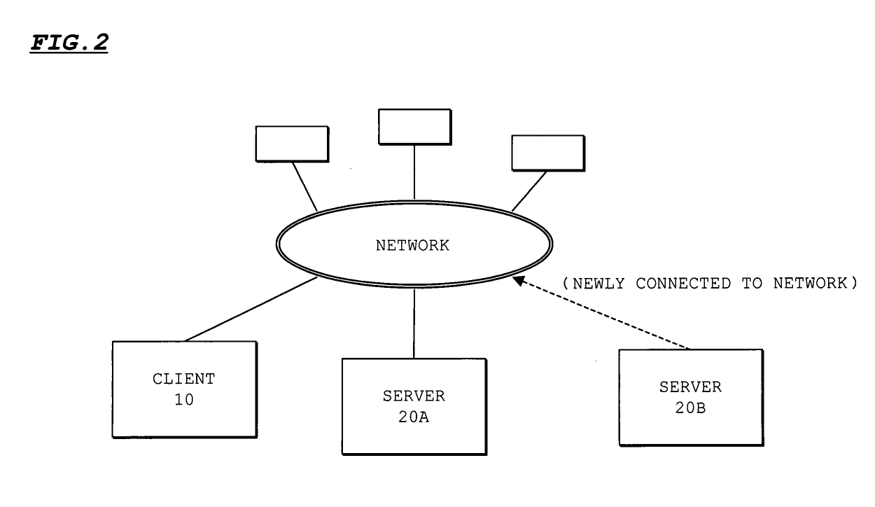

FIG. 2 shows a configuration example of a network system according to a first embodiment. The network system in this embodiment has a client 10 and servers 20A and 20B.

First, as the client 10 is connected to a network, the client 10 immediately sends by IP multicast an advertisement message indicative of the fact that it is connected to the network. If the server 20A does not send a response to the advertisement message sent from the client 10, the client 10 repeatedly sends the advertisement message by IP multicast until the server 20A sends a response. In the first embodiment, the client 10 does not have a configuration to receive IP multicast data.

In response to the advertisement message from the client 10, the server 20A sends by UDP unicast a subscription message indicative of its position on the network and its function. The client 10 receives the subscription message sent, and uses the received subscription message to determine to which server the client 10 is to be connected.

Thereafter, the server 20B is newly connected to the network and immediately sends by IP multicast an advertisement message indicative of the fact that it is connected to the network. This advertisement message is not received by the client 10, which does not have a configuration to receive IP multicast data, but is received by the server 20A where reception by IP multicast is possible.

The server 20A which is currently in operation as the server to which the client is connected uses the received advertisement message to compare the function of the newly connected server 20B against its own function (in the case where the server 20A is a client appliance with a server function, the function of its own server section to which the client is currently connected), and thereby determines to which of the servers the client is to be connected. If the newly connected server 20B is chosen as the server to which the client is to be connected, the server 20A sends, to every client connected to the network, a redirection message notifying of the new server to which the client is to be connected (the server 20B).

In this embodiment, when a client is newly connected to the network, the added client itself compares the functions of the servers on the network to determine to which server it is to be connected. When a server is newly connected to the network, the server that is currently in operation as the server to which existing clients are connected compares its own server function against the server function of the newly connected server, and decides to which of the two the clients are to be connected.

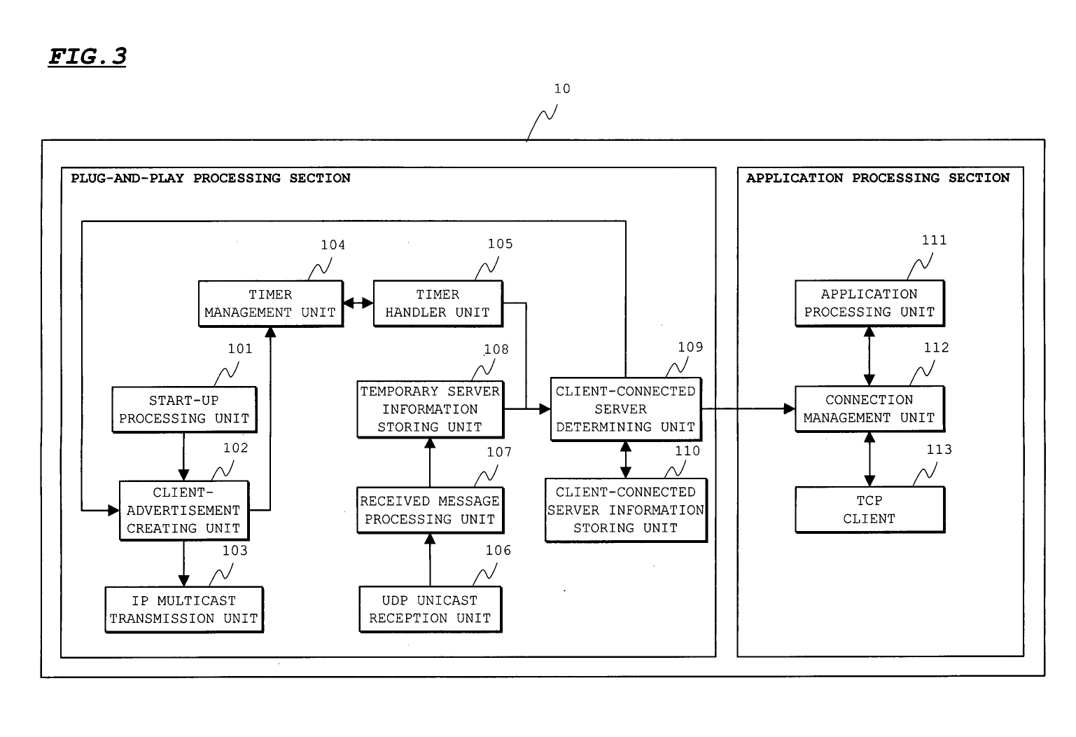

FIG. 3 is a function block diagram of the client 10.

The client 10 includes two function sections consisting of a plug-and-play processing section and an application processing section. The plug-and-play processing section has a start-up processing unit 101, a client-advertisement creating unit 102, an IP multicast transmission unit 103, a timer management unit 104, a timer handler unit 105, a UDP unicast reception unit 106, a received message processing unit 107, a temporary server information storing unit 108, a client-connected server determining unit 109 and a client-connected server information storing unit 110. The application processing section has an application processing unit 111, a connection management unit 112 and a TCP client 113.

The start-up processing unit 101 performs various initializing processings as the client 10 is booted up. The start-up processing unit 101 requests the client-advertisement creating unit 102 to send an advertisement message in order to notify servers connected to the network of the fact that the client 10 has just been booted up.

The client-advertisement creating unit 102 creates an advertisement message in accordance with the transmission request from the start-up processing unit 101, and requests the IP multicast transmission unit 103 to send the advertisement message. At this point, the client-advertisement creating unit 102 makes a timer registration request to the timer management unit 104 while specifying a certain time period in which a response to the advertisement message is to be received.

The IP multicast transmission unit 103 sends the advertisement message by IP multicast in accordance with the request from the client-advertisement creating unit 102.

The timer management unit 104 registers and deletes a timer handler. A registered handler is activated by the elapse of a specified time.

The timer handler unit 105 is a timer handler registered by the timer management unit 104. When a registered handler is activated, the timer handler unit 105 requests the temporary server information storing unit 108 to judge whether a stored received message exists or not.

The UDP unicast reception unit 106 receives packet data sent by UDP unicast. Packet data received by the UDP unicast reception unit 106 is sent to the received message processing unit 107.

The received message processing unit 107 discards, out of UDP packet data received from appliances that are connected to the network, data that is not a subscription message. The received message processing unit 107 has the temporary server information storing unit 108 temporarily keep a received subscription message until the timer handler unit 105 is activated.

The temporary server information storing unit 108 keeps the subscription message received by the UDP unicast reception unit 106 until the timer handler unit 105 is activated. At the time the timer handler unit 105 is activated, and in the case where no message has been stored in the temporary server information storing unit 108, in other words, the UDP unicast reception unit 106 has not received a subscription message, the temporary server information storing unit 108 makes another timer registration request to the timer management unit 104, and requests the IP multicast transmission unit 103 to send the advertisement message created by the client-advertisement creating unit 102. In the case where a message has been stored in the temporary server information storing unit 108 at the time the timer handler unit 105 is activated, the temporary server information storing unit 108 requests the client-connected server determining unit 109 to choose to which server clients are to be connected, and requests the timer management unit 104 to delete the timer.

The client-connected server determining unit 109 creates server information from the subscription message stored in the temporary server information storing unit 108. Then the client-connected server determining unit 109 narrows down servers using, in the order stated, the following conditions:

(A). servers that have higher functions, in other words, having more functions,

(B). servers to which more clients are connected, and

(C). the server that has the smallest server identifier, namely, the server having the lowest value character string when character string of the servers are compared as numerical values of ASCII characters.

The server chosen as the result of the screening is determined as the server to which clients are to be connected. Processing of selecting the client-connected server will be described later in detail.

The client-connected server information storing unit 110 stores information of the server to which clients are currently connected.

The application processing unit 111 processes functions that the client 10 uses via the network. The application processing unit 111 responds to requests from the network under the control of the connection management unit 112 and the TCP client 113.

The connection management unit 112 sends, when the TCP client 113 receives a redirection message, from the client-connected server, which requests to the client to disconnect from the client-connected sever and to connect to the newly connected sever, a disconnection request to the TCP client 113 and disconnects the client-server connection. When a request is made to connect to the server 20A or 20B, the connection management unit 112 requests the TCP client 113 to connect to the server. After the connection is thus established, the connection management unit 112 forwards, to the application processing unit 111, each message received from the TCP client 113.

The TCP client 113 connects to one of the servers according to the TCP/IP protocol, and controls communications.

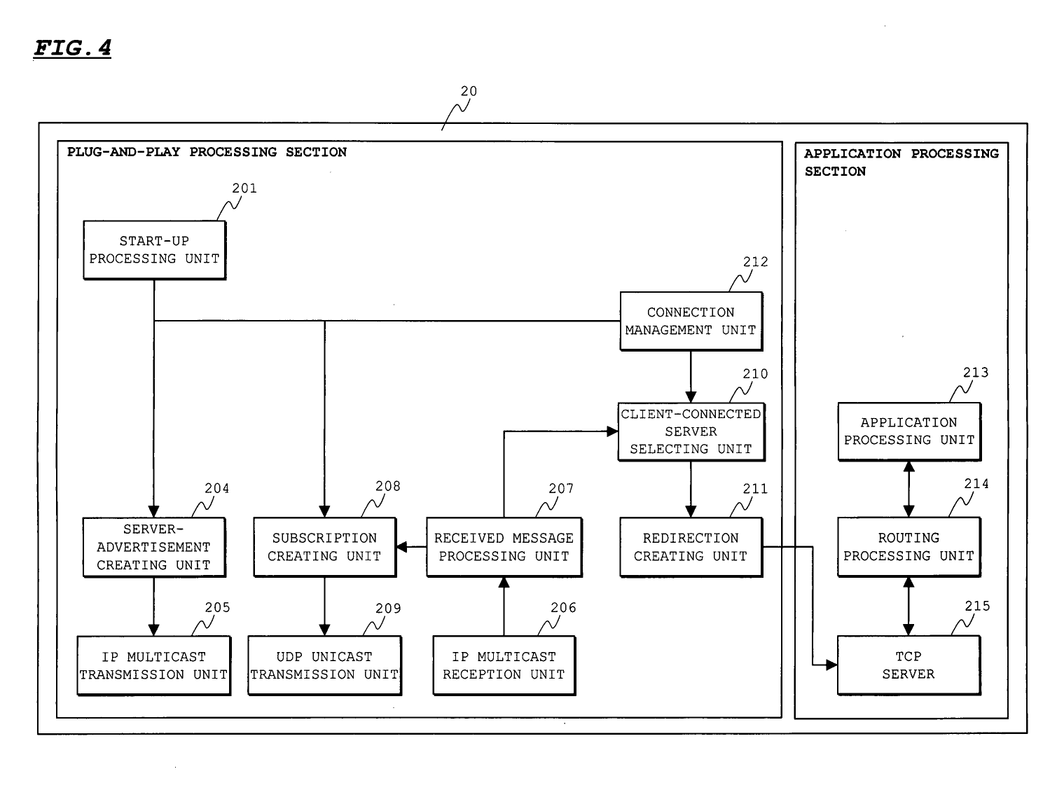

FIG. 4 is a function block diagram of a server 20 (the server 20A or 20B).

As shown in FIG. 4, the server 20 has two function sections consisting of a plug-and-play processing section and an application processing section. The plug-and-play processing section has a start-up processing unit 201, a server-advertisement creating unit 204, an IP multicast transmission unit 205, an IP multicast reception unit 206, a received message processing unit 207, a subscription creating unit 208, a UDP unicast transmission unit 209, a client-connected server selecting unit 210, a redirection creating unit 211, and a connection management unit 212. The application processing section has an application processing unit 213, a routing processing unit 214 and a TCP server 215.

The start-up processing unit 201 performs various initializing processing as the server 20 is booted up, and requests the server advertisement creating unit 204 to send an advertisement message in order to notify the network of the fact that the server 20 has just been booted up.

The server-advertisement creating unit 204 creates, from server information kept in the connection management unit 212, an advertisement message in accordance with the transmission request made by the start-up processing unit 201. The server-advertisement creating unit 204 requests the IP multicast transmission unit 205 to send the advertisement message.

The IP multicast transmission unit 205 sends by IP multicast the advertisement message requested by the server-advertisement creating unit 204 to send.

The IP multicast reception unit 206 receives an IP multicast message. The message received by the IP multicast reception unit 206 is sent to the received message processing unit 207.

The received message processing unit 207 processes the message received by the IP multicast reception unit 206. In the case where the received message is an advertisement message, the received message processing unit 207 requests the subscription creating unit 208 to create a subscription message in order to send the subscription message by UDP unicast to the client 10 that is the sender of the advertisement message, in response to the advertisement message.

In the case where the received message is an advertisement message, on the other hand, the received message processing unit 207 requests the client-connected server selecting unit 210 to compare the function of the server to which it belongs against the function of the server that has sent the advertisement message and to choose to which of the servers clients are to be connected.

The subscription creating unit 208 creates, from server information kept in the connection management unit 212, a subscription message in accordance with the transmission request from the received message processing unit 207. The subscription creating unit 208 requests the UDP unicast transmission unit 209 to send the subscription message.

The UDP unicast transmission unit 209 sends by UDP unicast the subscription message requested by the subscription creating unit 208 to send.

The client-connected server selecting unit 210 compares the function of the server to which it belongs against the function of the server that has sent the advertisement message received by the IP multicast reception unit 206. Using the server selecting conditions, the client-connected server selecting unit 210 determines which of the servers is to put into operation. In the case where the sender server is chosen as the operating server, the client-connected server selecting unit 210 requests the redirection creating unit 211 to create a redirection message.

The redirection creating unit 211 creates, in accordance with the request from the client-connected server selecting unit 210, a redirection message to be sent to clients connected to its server, and requests the TCP server 215 to send the redirection message.

The connection management unit 212 holds information of the server to which it belongs. When this server's connection with the client 10 is made, cut, or otherwise changed, the connection management unit 212 updates the server information, which indicates the number of clients connected to this server, upon request from the TCP server 215.

The application processing unit 213 processes functions the server 20 provides via the network.

The routing processing unit 214 responds to requests from the network. The routing processing unit 214 holds a routing table inside for seamless communications of messages between an external server of plural clients 10A, 10B, 10C . . . and the application processing unit 213.

The TCP server 215 is a server to accept a connection from the client 10, and controls a communication with the client 10 according to the TCP/IP protocol. Messages received by the TCP server 215 are forwarded to the routing processing unit 214. The TCP server 215 also sends a redirection message created by the redirection creating unit 211.

Next, a description is given on messages handled in the network system according to the first embodiment.

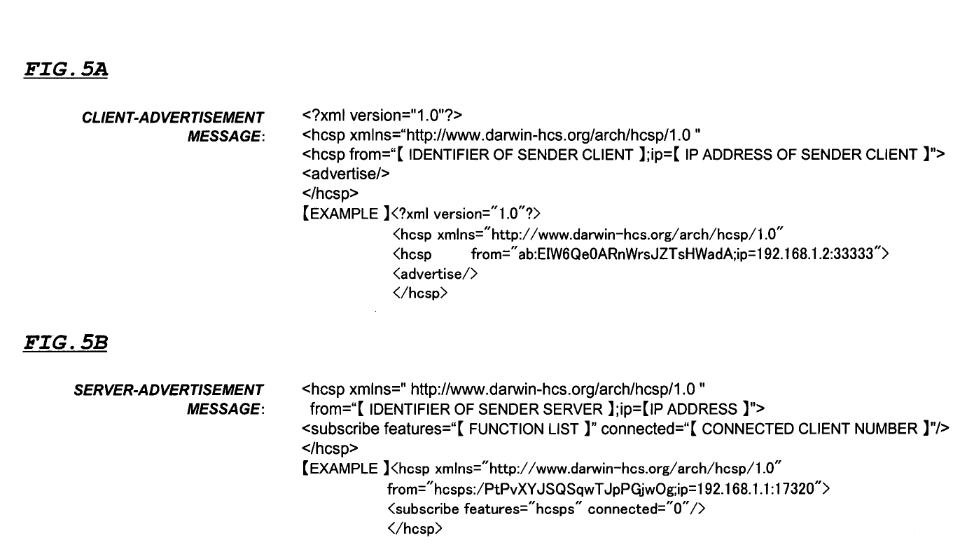

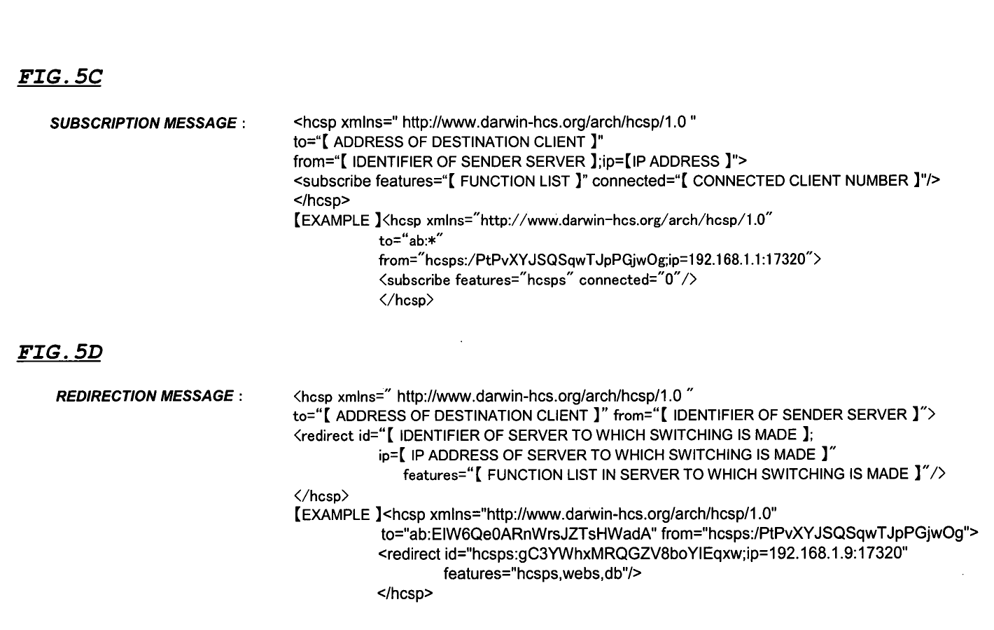

FIGS. 5A, 5B, 5C and 5D show examples of a client-advertisement message, a server-advertisement message, a subscription message and a redirection message that are handled in the network system according to the first embodiment. Those messages are used for notification of a client or server being connected to the network, notification of switching from one client-connected server to another, and the like.

An advertisement message is information sent by multicast from the client 10 or server 20 to indicate that client 10 or server 20 is on the network when client 10 or server 20 has been connected to the network. The advertisement message sent by server 20 includes information to indicate the position of the server 20 on the network and its function.

Hereinafter, the advertisement message sent by client 10 is referred to as “client-advertisement message”, and the advertisement message sent by sever 20 is referred to as “server-advertisement message”.

FIG. 5A shows an example of the client-advertisement message. In the example of FIG. 5A, the client-advertisement message is written in a markup language such as XML, and constitutes information defined as “advertise” and sent from a specific address written after “from” to all resources connected to the network.

FIG. 5B shows an example of the server-advertisement message. In the example of FIG. 5B, the server-advertisement message is written in a markup language such as XML, and information defined as “subscribe” is sent from a specific address written after “from” to all resources connected to the network.

A subscription message is information sent from the server 20 to indicate the position of the server 20 on the network and its function when a client-advertisement message is received from the client 10.

FIG. 5C shows an example of the subscription message. In the example of FIG. 5C, the subscription message is written in a markup language such as XML, and information defined as “subscribe” is sent from a specific address written after “from” to a specific address written after “to”.

A redirection message is information sent from the client-connected server to indicate that a server 20 newly connected to the network is a client-connected server.

FIG. 5D shows an example of the redirection message. In the example of FIG. 5D, the redirection message is written in a markup language such as XML, and constitutes information defined as “redirect” and sent from a specific address written after “from” to a specific address written after “to”.

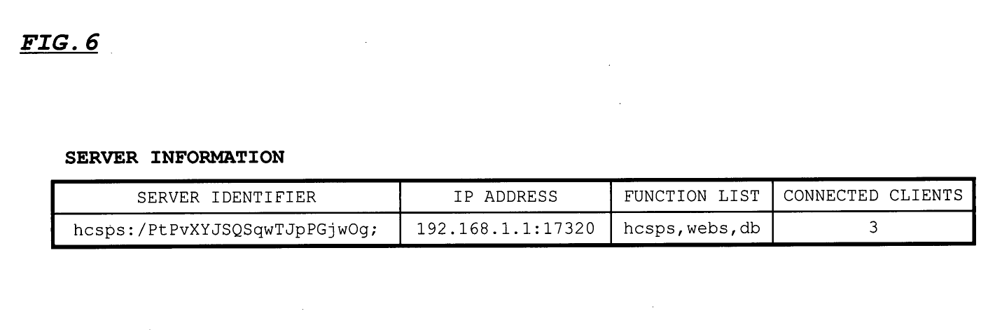

FIG. 6 shows an example of server information managed by a server.

Server information is a group of pieces of information on a server, and contains a server identifier, an IP address, a function list, and information indicative of how many clients are connected to the server.

The server identifier shows the name of the server.

The IP address shows the IP address of the server.

The function list is a list of all functions the server has and is expressed in character strings associated with the functions. A server having a larger number of character strings, namely, a larger number of functions, is a server of higher function.

The connected client number shows the number of clients connected to the server.

The server information is kept in the server 20 as their own information, and is embedded in a subscription message to be sent to a client.

Receiving the subscription message, the client reads each piece of data in the message to create or update server information.

How the above network system configuration operates will be described next.

First, the operation of when a client is connected to a server is described.

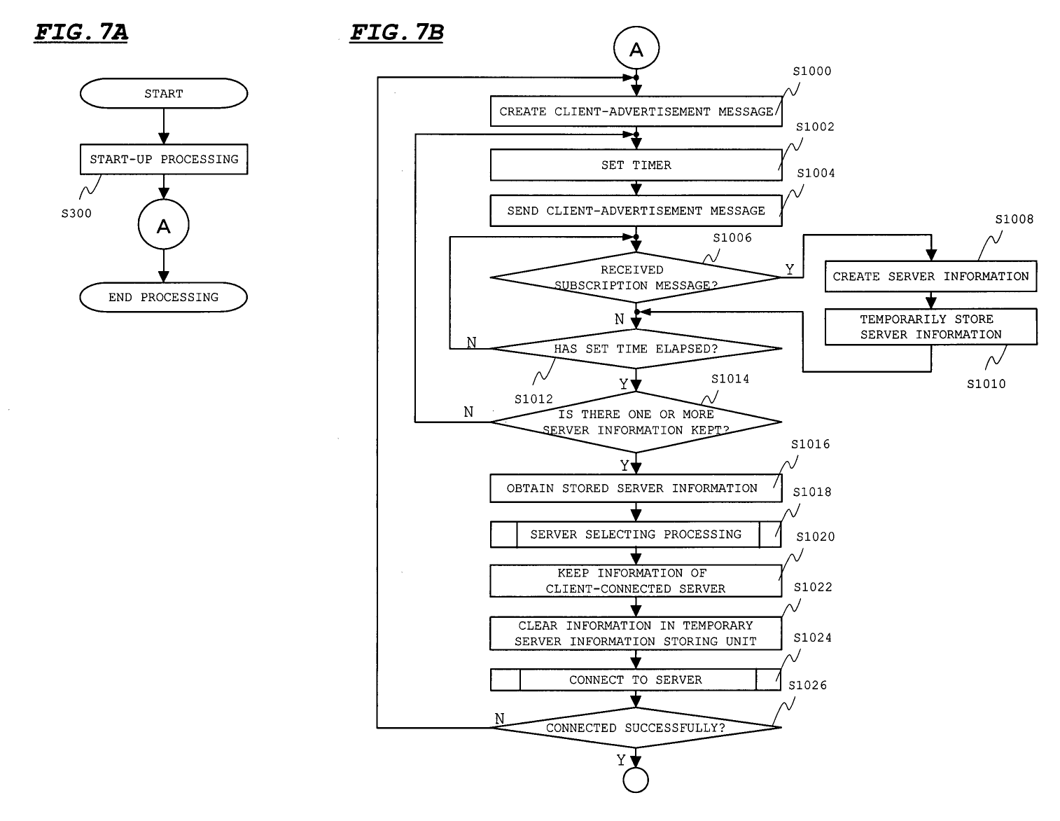

FIGS. 7A and 7B are flow charts schematically showing processing that is executed when the client 10 is booted up after the start-up of the server 20A, and is connected to the server 20A in the configuration shown in FIG. 2.

First, at a start-up instruction, the start-up processing unit 101 in the client 10 performs start-up processing (Step S300).

Then the client-advertisement creating unit 102 creates a client-advertisement message (Step S1000).

Once the client-advertisement message is created in the client-advertisement creating unit 102, the timer management unit 104 sets a timer specifying a certain time (Step S1002), and requests the IP multicast transmission unit 103 to perform processing of transmitting the client-advertisement message created in the client-advertisement creating unit 102.

Receiving the request, the IP multicast transmission unit 103 sends the client-advertisement message (step S1004). The UDP unicast reception unit 106 waits for reception of a subscription message which is to be sent from the server 20A in response to the client-advertisement message (Step S1006).

When the UDP unicast reception unit 106 receives the subscription message (Step S1006Y), the received message processing unit 107 creates server information from the received subscription message (Step S1008). The created server information is temporarily kept in the temporary server information storing unit 108 (Step S1010).

On the other hand, when no subscription message is received by the UDP unicast reception unit 106 in Step S1006 (Step S1006N), whether the certain time set on the timer has elapsed or not is judged (Step S1012). In the case where the certain time has not passed yet (Step S1012N), the processing moves to Step S1006 to wait for reception of a subscription message from the server 20A.

In the case where it is judged in Step S1012 that the certain time set on the timer has passed (Step S1012Y), the timer management unit 104 deletes the timer and judges whether the temporary server information storing unit 108 is keeping server information or not (Step S1014).

When it is judged in Step S1014 that no server information is kept in the temporary server information storing unit 108 (Step S1014N), the timer management unit 104 again sets a timer specifying a certain time (Step S1002), and has the IP multicast transmission unit 103 send the client-advertisement message (Step S1004).

When it is judged in Step S1014 that one or more pieces of server information are kept in the temporary server information storing unit 108 (Step S1014Y), the client-connected server determining unit 109 uses the server information kept in the temporary server information storing unit 108 to perform server selecting processing (Step S1018). Details of the server selecting processing will be described later. Server information of the server chosen through the server selecting processing is stored in the client-connected server information storing unit 110 (Step S1020), whereas the information temporarily kept in the temporary server information storing unit 108 is discarded (Step S1022).

Next, the connection management unit 112 exerts control to connect to the server determined in Step S1018 as the server to which clients are to be connected, the server 20A in the configuration example of FIG. 2. Controlled by the connection management unit 112, the TCP client 113 connects the client 10 to the server 20A.

When the client 10 is successfully connected to the server in Step S1024 (Step S1026Y), this processing is ended. On the other hand, when the connection fails (Step S1026N), the processing moves to Step S1000.

Described next is how clients operate when a new server is connected to the network.

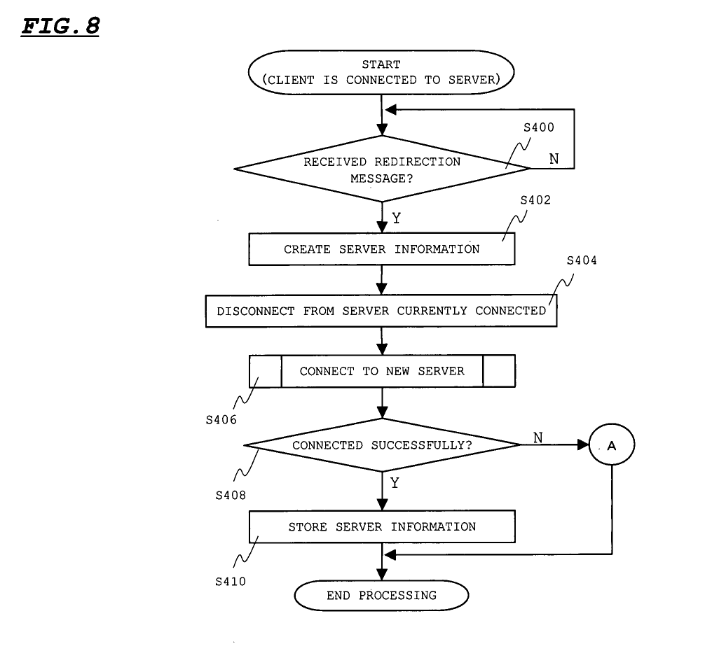

FIG. 8 is a flow chart schematically showing processing of connecting the client 10 to a server when the server 20B is newly connected to the network in the configuration shown in FIG. 2. The description below takes as an example a case where the server 20B newly connected to the network is chosen as the new server to which clients are to be connected.

As the server 20B is newly connected to the network, the server 20A to which the clients are currently connected judges to which of the servers the clients are to be connected.

If the newly connected server 20B is judged as the server to which the clients are to be connected, the server 20A to which the clients are currently connected sends, to every client, a redirection message which contains information instructing the clients to switch to another server and information specifying the server to which the clients are to be switched. The processing performed in the servers in relation to this connection processing will be described later.

When the redirection message is received by the TCP client 113 of the client 10 (Step S400Y), the received message processing unit 107 creates server information from the information contained in the received redirection message (Step S402).

Next, the connection management unit 112 exerts control to disconnect from the server 20A to which the client 10 is currently connected (Step S404), and the TCP client 113 connects the client 10 to the server 20B chosen as the server to which the clients are to be connected (Step S406).

When the client 10 is successfully connected to the server 20B in Step S406 (Step S408Y), the client-connected server determining unit 109 gives the server information to the client-connected server information storing unit 110 to store (Step S410), thereby ending this processing. On the other hand, when the connection fails in Step S406 (Step S408N), the processing moves to Step S1000 of FIG. 7B.

The server selection processing executed in Step S1018 of FIG. 7B is described next. This processing is executed by the client-connected server determining unit 109 in the client 10.

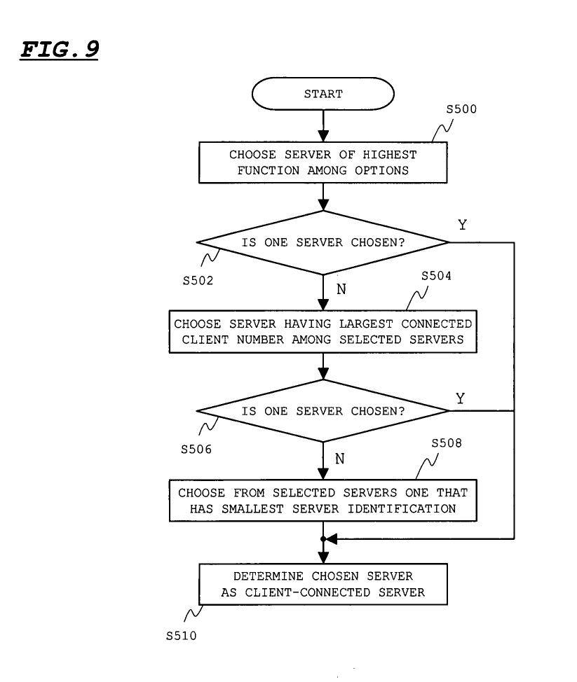

FIG. 9 is a flow chart schematically showing processing of choosing, from one or more servers, the only server to which this client is to be connected.

First, server information (see FIG. 6) of the selectable servers (20A and 20B in this example) is consulted to compare the function list information contained in each server information. The server or servers found to have the largest number of functions are chosen (Step S500).

If only one server is chosen in Step S500 (Step S502Y), the chosen server is determined as the server to which the clients are to be connected (Step S510). On the other hand, if plural servers are chosen in Step S500 (Step S502N), the connected client number contained in each server information is compared to select the server or servers having the largest connected client number (Step S504).

If only one server is chosen in Step S504 (Step S506Y), the chosen server is determined as the server to which the clients are to be connected (Step S510). If plural servers are chosen in Step S504 (Step S506N), one server is selected from these servers (Step S508). The server selected in Step S508 is, for example, the server that has the smallest server identifier, in other words, the server having the lowest value character string when character strings of the servers are compared as numerical values of ASCII characters. The thus chosen server is determined as the server to which the clients are to be connected (Step S510).

A server operation is described next.

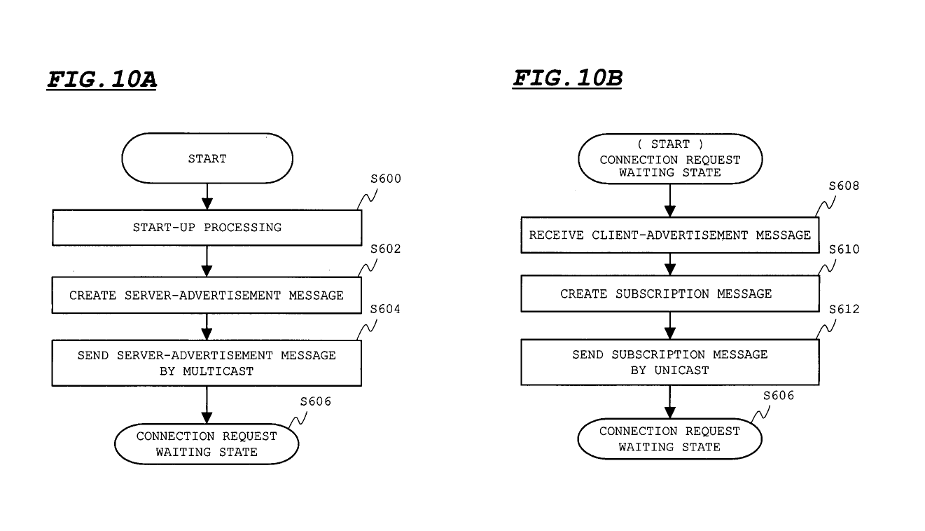

FIGS. 10A and 10B are flow chart schematically showing processing that is executed in the server 20A from the start-up of the client 10 following the start-up of the server 20A until the client 10 is connected to the server 20A in the configuration shown in FIG. 2.

As shown in FIG. 10A, booting up the server 20A puts the start-up processing unit 201 into performing start-up processing (Step S600), and the server-advertisement creating unit 204 creates a server-advertisement message (Step S602).

The server-advertisement message created in the server-advertisement creating unit 204 is sent by the IP multicast transmission unit 205 (Step S604).

As the IP multicast transmission unit 205 sends the server-advertisement message, the server 20A shifts to a connection request waiting state to wait for a connection request from the client 10 (Step S606).

FIG. 10B is a flow chart schematically showing processing executed in the server 20A when the server 20A in the connection request waiting state receives a client-advertisement message sent from the client 10.

The client 10 sends a client-advertisement message by multicast in Step S1004 of FIG. 7B. This client-advertisement message is received by the IP multicast reception unit 206 of the server 20A, and the received client-advertisement message is handed over to the received message processing unit 207.

The received message processing unit 207 confirms that the message handed over from the reception unit 206 is indeed a client-advertisement message (Step S608). Then the subscription creating unit 208 creates a subscription message to be sent to the client 10 that has sent this client-advertisement message (Step S610).

Once the subscription message is created, the subscription creating unit 208 requests the UDP unicast transmission unit 209 to send this subscription message to the client 10 that is the sender of the client-advertisement message.

The subscription message is thus sent to the client that is the sender of the client-advertisement message (Step S612). Thereafter, the server 20A shifts to the connection request waiting state to wait for a connection request from the client 10 (Step S606).

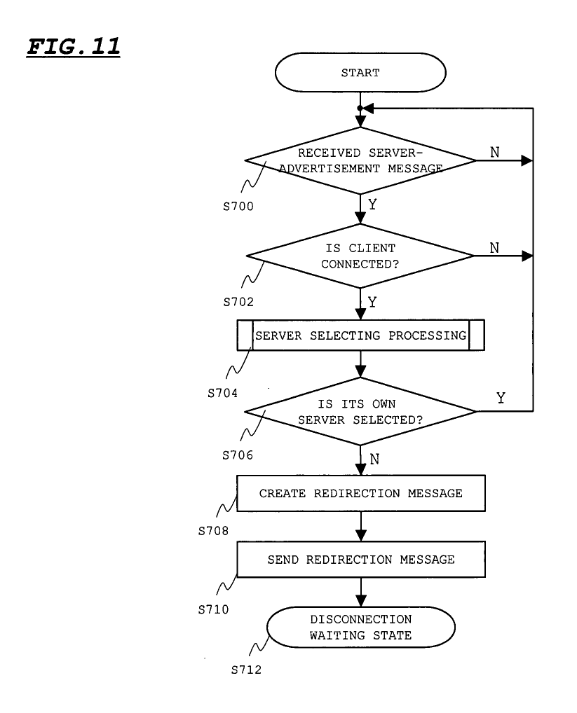

FIG. 11 is a flow chart schematically showing processing that is executed when an existing server on the network receives a server-advertisement message from a server newly connected to the network through the processing of Step S604 described with reference to FIG. 10A.

When the IP multicast reception unit 206 in the server 20A which has been connected to the network is monitoring for a reception of a server-advertisement message (Step S700), the IP multicast reception unit 206 receives a server-advertisement message sent from the server 20B newly connected to the network (Step S700Y). In this case, the client-connected server selecting unit 210 of the server 20A consults server information stored in the connection management unit 212 to judge whether the server 20A is set as the server to which the clients are to be connected (Step S702).

If it is judged that the server 20A is not set as the server to which the clients are to be connected (S702N), the processing moves to Step S700.

If the server 20A is judged as the server to which the clients are to be connected, on the other hand (Step S702Y), the client-connected server selecting unit 210 creates server information from the received server-advertisement message, and compares the created server information against its own server information kept in the connection management unit 212 to perform server selecting processing (Step S704). The server selecting processing in Step S704 is identical with the above-described server selecting processing in the client (see FIG. 9). In Step S704, options correspond to those in Step S500 of FIG. 9 are the server 20A itself and the newly connected server 20B.

In the case where the client-connected server selecting unit 210 chooses, as a result of the server selecting processing, itself as its own server (Step S706Y), the processing moves to Step S700.

On the other hand, in the case where the server chosen in Step S704 is the newly connected server 20B (Step S706N), the redirection creating unit 211 creates a redirection message for switching to the server 20B (Step S708), and the TCP server 215 sends the created redirection message to the clients connected to the server 20A (Step S710). Thereafter, the server 20A goes into a disconnection waiting state.

While connected to a server, the client 10 keeps checking whether this server is operating or not. Whether a server connected to a client is operating or not is checked by common methods used in TCP processing. For example, one method is used in which SYN packets are regularly sent to the server to judge that the connection between the server and the client is held when an ACK is received in response and to judge that the connection is cut when no ACK is received.

Detecting that the server 20 to which the client 10 is connected is shut down, in other words, when disconnection from the server 20 is detected, the client-connected server determining unit 109 in the client 10 deletes, from the client-connected server information storing unit 110, server information of the server to which the client 10 has been connected. The connection management unit 112 then exerts control to disconnect the client 10 from the server 20 to which the client 10 has been connected, and the TCP client 113 breaks the connection with the server 20.

Thereafter, the client 10 performs the processing of FIGS. 7A and 7B and FIG. 9 to select and set a new server to which the client 10 is to be connected. Information of the server set as the server to which the client 10 is to be connected is held in the client-connected server information storing unit 110.

According to the first embodiment, when a client is connected to a network, the client itself can uniquely determine to which server it is to be connected based on server information received from servers. When a server is newly connected to the network, the new server notifies existing servers of the fact that it is connected to the network, and server information contained in this notification is used to determine the server to which clients are to be connected. Notified of the decision, the clients can uniquely determine to which server they are to be connected.

As has been described, according to the first embodiment, the server to which clients are to be connected can be determined automatically and uniquely when there is a change in network configuration. The first embodiment is therefore capable of lessening the user's burden in dealing with a change in network configuration.

(Second Embodiment)

A second embodiment of the present invention differs from the first embodiment in that clients receive a server-advertisement message sent by multicast from a server.

To elaborate, in the first embodiment, clients cannot receive a server-advertisement message sent in Step S604 of FIG. 10A, namely, a server-advertisement message sent by multicast from a server when the server is newly connected to the network. Accordingly, when a new server is connected to the network, the server determines to which server the clients are to be connected, and the decision is sent in the form of a redirection message to the clients. The clients are thus instructed to connect to the determined server.

In contrast, each client in the second embodiment has an IP multicast reception unit 114 in addition to the client configuration of the first embodiment. The configurational addition enables clients in the second embodiment to receive the multicast server-advertisement message. When a server is newly connected to the network, the clients receive a server-advertisement message sent from the new server by multicast, and accordingly perform client-connected server selecting processing. Since it is not a server but clients that perform the client-connected server selecting processing when a new server is connected to the network, the second embodiment does not require the server to execute processing for creation and transmission of a redirection message.

The second embodiment is described below.

In the second embodiment, components identical to those in the first embodiment are denoted by the same reference symbols. Descriptions on function sections and processing that are identical to those in the first embodiment are omitted below and only function sections and processing that are different from those in the first embodiment will be described.

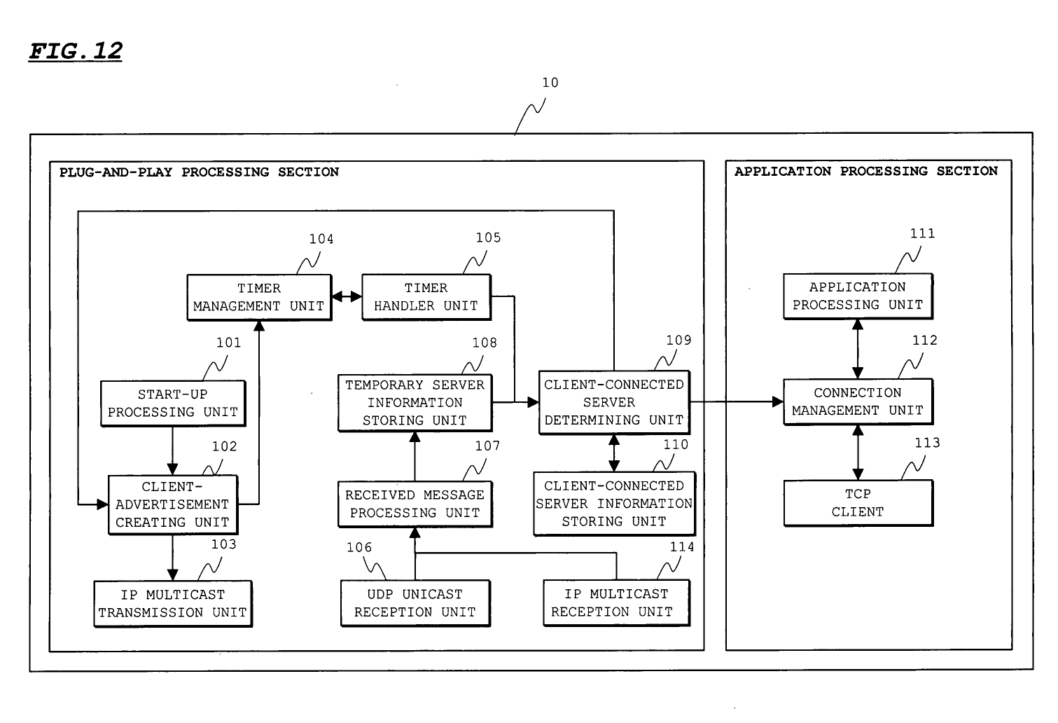

FIG. 12 is a function block diagram of a client 10.

The client 10 has two function sections consisting of a plug-and-play processing section and an application processing section. The plug-and-play processing section has a start-up processing unit 101, a client-advertisement creating unit 102, an IP multicast transmission unit 103, a timer management unit 104, a timer handler unit 105, a UDP unicast reception unit 106, a received message processing unit 107, a temporary server information storing unit 108, a client-connected server determining unit 109, a client-connected server information storing unit 110, and an IP multicast reception unit 114. The application processing section has an application processing unit 111, a connection management unit 112 and a TCP client 113.

The IP multicast reception unit 114 receives an IP multicast message. The received message is sent to the received message processing unit 107.

Of messages received by the UDP unicast reception unit 106 or the IP multicast reception unit 114, messages other than subscription messages and server-advertisement messages are discarded by the received message processing unit 107. When a subscription message is received by the UDP unicast reception unit 106, the received message processing unit 107 makes the temporary server information storing unit 108 keep the received subscription message until the timer handler unit 105 is activated. On the other hand, when a server-advertisement message is received by the IP multicast reception unit 114, the received message processing unit 107 makes the temporary server information storing unit 108 keep the received server-advertisement message until the client-connected server determining unit 109 finishes processing of determining to which server clients are to be connected.

The temporary server information storing unit 108 keeps messages received by the UDP unicast reception unit 106 or the IP multicast reception unit 114. In the case where no message has been stored in the temporary server information storing unit 108, in other words, the UDP unicast reception unit 106 has received no subscription message, at the time the timer handler unit 105 is activated, the temporary server information storing unit 108 makes another timer registration request to the timer management unit 104, and requests the IP multicast transmission unit 103 to send a client-advertisement message created by the client-advertisement creating unit 102. In the case where a message has been stored in the temporary server information storing unit 108 at the time the timer handler unit 105 is activated, the temporary server information storing unit 108 requests the client-connected server determining unit 109 to choose to which server clients are to be connected, and requests the timer management unit 104 to delete the timer.

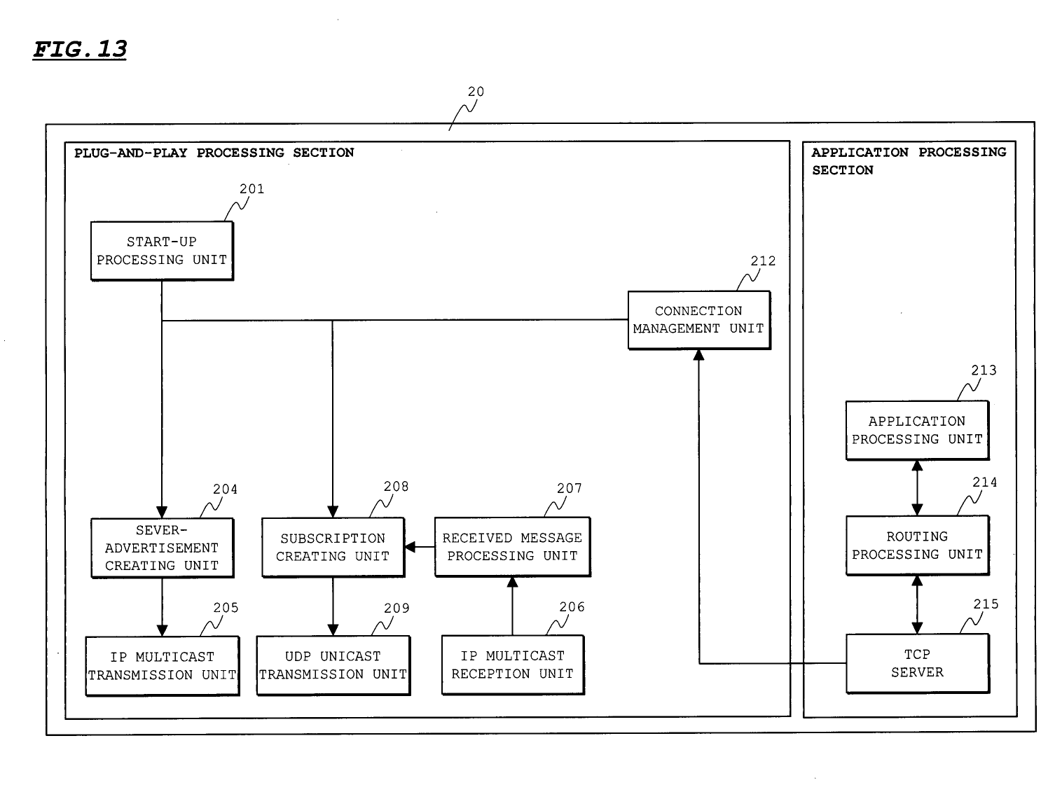

FIG. 13 is a function block diagram of a server 20 (the server 20A or 20B).

As shown in FIG. 13, the server 20 has two function sections consisting of a plug-and-play processing section and an application processing section. The plug-and-play processing section has a start-up processing unit 201, a server-advertisement creating unit 204, an IP multicast transmission unit 205, an IP multicast reception unit 206, a received message processing unit 207, a subscription creating unit 208, a UDP unicast transmission unit 209 and a connection management unit 212. The application processing section has an application processing unit 213, a routing processing unit 214 and a TCP server 215.

The client-connected server selecting unit 210 and the redirection creating unit 211 which are provided in the server 20 of the first embodiment are omitted from the server 20 of the second embodiment.

Of messages received by the IP multicast reception unit 206, messages other than client-advertisement messages are discarded by the received message processing unit 207. In the case where a received message is an client-advertisement message, the reception message processing unit 207 requests the subscription creating unit 208 to create a subscription message in order to send the subscription message by UDP through the UDP unicast transmission unit 209 unicast to the client 10 that is the sender of the client-advertisement message, in response to the client-advertisement message.

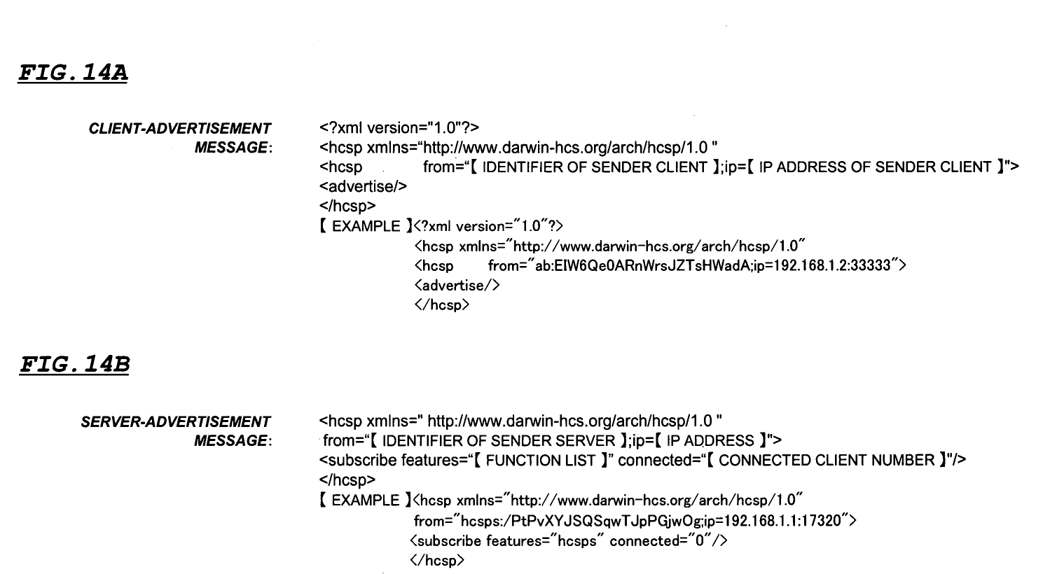

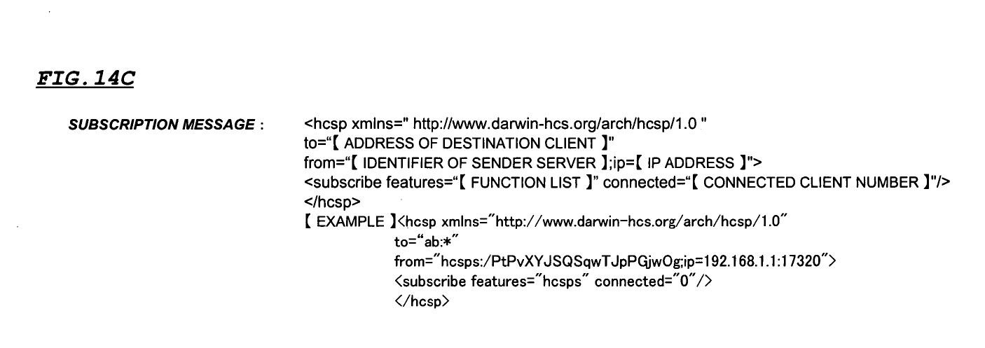

FIGS. 14A 14B and 14C show examples of messages that are handled in the network system according to the second embodiment, namely, a client-advertisement message, a server-advertisement message and a subscription message. These messages that are handled in the second embodiment have the same configurations as the configurations of the messages that are handled in the first embodiment. No redirection message is necessary since, as has been described, servers in the second embodiment do not perform processing of switching the server to which clients are to be connected. Server information handled in the second embodiment is identical to server information handled in the first embodiment.

Described next is how clients and servers operate.

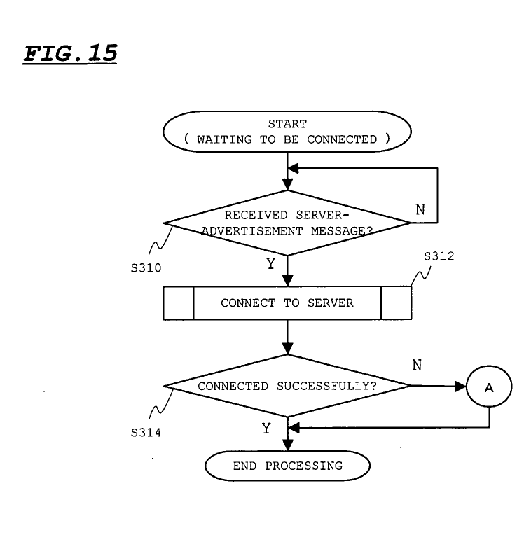

FIG. 15 is a flow chart schematically showing operation processing performed in the client 10 when a server 20A is connected to the network while the client 10 is waiting to be connected to a server. Operation processing performed in the client 10 of this embodiment when the client 10 is connected to the network (booted up) after the server 20A is connected to the network (booted up) is identical to the processing (FIGS. 7A and 7B) in the first embodiment, and a description thereof is omitted.

In the case where the IP multicast reception unit 114 in the client 10 receives a server-advertisement message while the client 10 is waiting to be connected to a server (Step S310Y), the client-connected server determining unit 109 creates server information from the received server-advertisement message. The created server information is stored in the client-connected server information storing unit 110. Next, the connection management unit 112 exerts control to connect to the server 20A that has sent the server-advertisement message, and the TCP client 113 connects the client 10 to this server 20A (Step S312).

When the client 10 is successfully connected to the server in Step S312 (Step S314Y), this processing is ended. On the other hand, when the connection fails in Step S312 (Step S314N), the processing moves to Step S1000 of FIG. 7B.

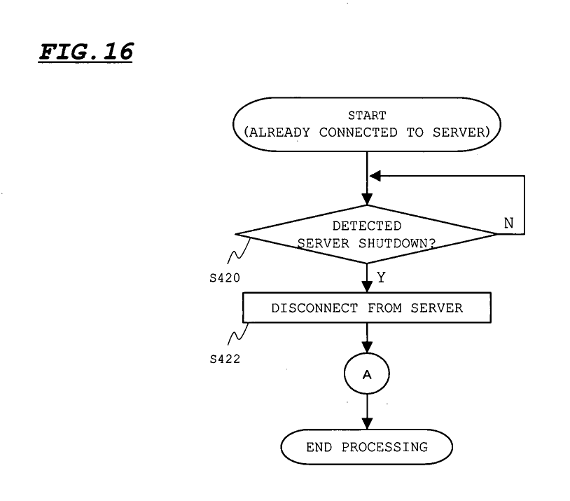

FIG. 16 is a flow chart schematically showing processing performed in the client 10 when the server to which it is connected stops operating in the configuration shown in FIG. 2.

While connected to a server, the client 10 keeps checking whether this server is operating or not. Whether a server connected to the client 10 is operating or not is checked by common methods used in TCP processing. For example, one method is used in which the client 10 regularly sends SYN packets to the server to judge that the connection with the server is held when an ACK is received in response and to judge that the connection is cut when no ACK is received.

Detecting that the server 20 to which the client 10 is connected is shut down, in other words, when disconnection from the server 20 is detected (Step S420Y), the client-connected server determining unit 109 in the client 10 deletes, from the client-connected server information storing unit 110, server information of the server to which the client 10 has been connected. The connection management unit 112 then exerts control to disconnect the client 10 from the server 20 to which the client 10 has been connected, and the TCP client 113 breaks the connection with the server 20 (Step S422). Thereafter, the processing moves to Step S1000 (see FIG. 7B).

Described next is operation processing performed in the client 10 when a server 20B is newly connected to the network after the client 10 is connected to the server 20A.

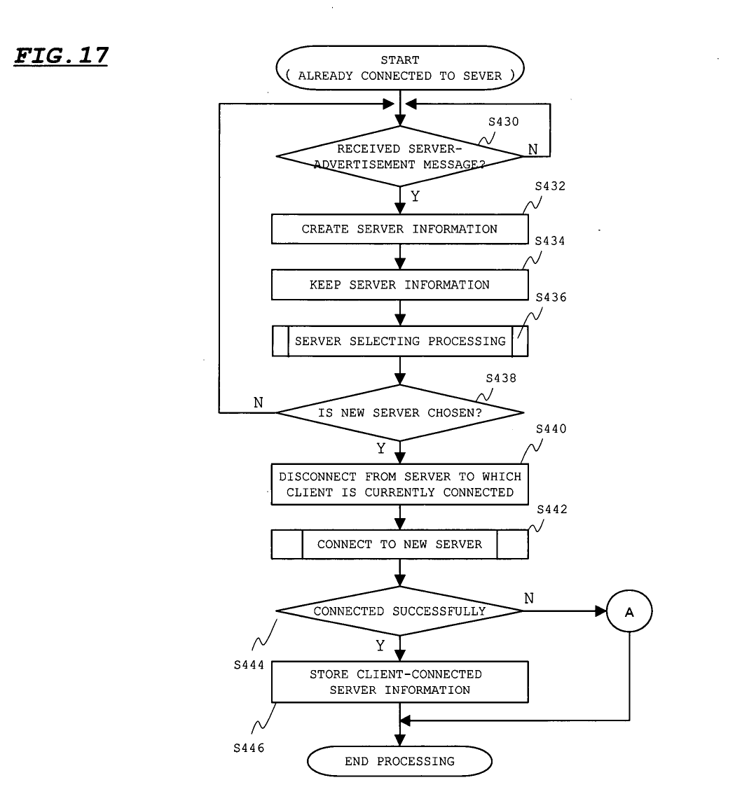

FIG. 17 is a flow chart schematically showing operation processing performed in the client 10 when the server 20B is newly connected to the network after the client 10 is connected to the server 20A in the configuration shown in FIG. 2.

While the client 10 is waiting for a reception of a server-advertisement message (Steps S430 and S430N), a server-advertisement message from the server 20B, namely, a server-advertisement message notifying of the new addition of the server 20B to the network, is received by the IP multicast reception unit 114 (Step S430Y). The received message processing unit 107 creates server information from information contained in the received server-advertisement message (Step S432), and the server information is kept in the temporary server information storing unit 108 (Step S434).

Then the client-connected server determining unit 109 executes server selecting processing using server information kept in the temporary server information storing unit 108 and server information kept in the client-connected server information storing unit 110 (Step S436). Specifically, the client-connected server determining unit 109 uses the two types of server information to compare the function of the server newly connected to the network against the function of the server that is currently set as the server to which clients are to be connected. The client-connected server determining unit 109 narrows down servers using, in the order stated, the following conditions:

(A). servers that have higher functions, in other words, having more functions,

(B). servers to which more clients are connected, and

(C). the server that has the smallest server identifier.

The server chosen as the result of the screening is determined as the server to which clients are to be connected.

If the server newly connected to the network is chosen in this step as the server to which clients are to be connected (Step S438Y), the connection management unit 112 exerts control to disconnect the client 10 from the server 20A to which the client 10 has been connected (Step S440).

The connection management unit 112 then exerts control to connect to the server determined in Step S440 as the server to which clients are to be connected. Controlled by the connection management unit 112, the TCP client 113 connects the client 10 to this server 20B.

When the client 10 is successfully connected to the server in Step S442 (Step S444Y), server information is stored in the client-connected server information storing unit 110 by the client-connected server determining unit 109 (Step S446), and this processing is ended. On the other hand, when the connection fails in Step S442 (Step S444N), the processing moves to Step S1000 of FIG. 7B.

Finally, a server operation in the second embodiment is described.

Processing performed in a server when a client is booted up after the start-up of the server and is connected to the server is identical with the processing (see FIGS. 10A and 10B) in the first embodiment.

In the case where a server is newly connected to the network when one of the existing servers is set as the server to which clients are to be connected, the current server maintains the connections with the clients unless the connection with the clients are broken as a result of the client-connected server selecting processing performed in the clients. When the connections between the current server and the clients are broken as a result of the server selecting processing in the clients, the current server updates server information stored in the connection management unit 212, so that the disconnection is reflected on the server information. Specifically, the current server decrements the connected client number stored as server information in the connection management unit 212.

According to the second embodiment, when a server is connected to a network, this server notifies clients of the fact that it is connected to the network. The clients can uniquely determine to which server they are to be connected from server information contained in the notification, and are connected to the determined server.

Embodiments of the present invention have been described above. It is needless to say that the present invention is not limited to those embodiments, and is open to various modifications.

For instance, communication protocols other than TCP/IP and UDP, which are employed in the embodiments of the present invention, may be employed for communications over a network.

Messages used between a client and a server may be written in markup languages other than XML.

Messages exchanged between a client and a server by IP multicast may instead be exchanged by IP broadcast.

The present invention can be modified suitably within the range of the technical concept defined in the scope of patent claims.

What is claimed is:

1. A networkable appliance connected to a network, comprising:
a connection notification transmitting unit for sending, to appliances on the network, information to notify the appliances of the fact of being connected to the network;
an information receiving unit for receiving information sent from other appliances on the network; and
a connection management unit which, when information received by the information receiving unit is response information sent from an appliance with a server function in response to the information sent by the connection notification transmitting unit, compares the server function of one appliance to the server function of another appliance based on the received response information, which determines, in accordance with the result of the comparison, to which appliance with a server function the networkable appliance is to be connected, and which exerts control to connect the networkable appliance to the determined appliance with a server function.

2. A networkable appliance according to claim 1, further comprising a memory unit for storing the appliance with a server function to which the networkable appliance is connected by the connection management unit in association with the response information received by the information receiving unit from this appliance with a server function.

3. A networkable appliance according to claim 1, further comprising a disconnection detecting unit for detecting that a connection to the appliance with a server function is cut,
wherein, when the disconnection detecting unit detects that a connection to the appliance with a server function is cut, the connection notification transmitting unit retransmits, to the appliances on the network, the information to notify the appliances of the fact of being connected to the network, and
wherein, based on response information sent from the appliance with a server function in response to the information retransmitted from the connection notification transmitting unit, the connection management unit determines to which appliance with a server function the networkable appliance is to be newly connected, and exerts control to connect the networkable appliance to the determined appliance with a server function.

4. A networkable appliance according to any one of claims 1 to 3, further comprising:
a memory unit for storing information of an appliance with a server function that is chosen by the networkable appliance as the server to which the networkable appliance is to be connected; and
a server determining unit which, when information received by the information receiving unit is information sent from an appliance with a server function that is newly connected to the network, compares the server function of one appliance to the server function of another appliance based on the received information and the information stored in the memory unit, and which determines, in accordance with the result of the comparison, to which appliance with a server function the networkable appliance is to be connected.

5. A networkable appliance connected to a network, comprising:
an information receiving unit for receiving information sent from appliances on the network;
a memory unit for storing information of an appliance with a server function that is chosen by the networkable appliance as the server to which the networkable appliance is to be connected; and
a server determining unit which, when information received by the information receiving unit is information sent from an appliance with a server function that is newly connected to the network, compares the server function of one appliance to the server function of another appliance based on the received information and the information stored in the memory unit, and which determines, in accordance with the result of the comparison, to which appliance with a server function the networkable appliance is to be connected; and
a connection management unit which exerts control to connect the networkable appliance to the appliance with a server function that is determined by the server determining unit.

6. A networkable appliance according to claim 5, wherein the connection management unit disconnects, when the appliance with a server function that is determined by the server determining unit is not an appliance with a server function to which the networkable appliance is currently connected, the networkable appliance from the currently connected appliance, and connects the networkable appliance to the appliance that is determined by the server determining unit.

7. A networkable appliance with a server function, comprising:
a connection notification transmitting unit for sending, to appliances on a network, information to notify the appliances of the fact of being connected to the network;
an information receiving unit for receiving information sent from appliances on the network;
a memory unit for storing information of its own server function; and
a client-connected server determining unit which, when information received by the information receiving unit is information notifying of the fact that another appliance with a server function is connected to the network, compares the function of its own against the function of the other appliance based on the received information and the information stored in the memory unit, and which determines, in accordance with the result of the comparison, to which appliance with a server function the appliances on the network are to be connected; and
a client-connected server notification unit for sending, to the appliances connected to the network, information indicative of the appliance that is determined by the client-connected server determining unit as the server to which the appliances are to be connected.
